(19) United States
(12) Patent Application Publication
(10) Pub. No.: US 2006/0235939 A1
(43) Pub. Date: Oct. 19, 2006

(54) Apparatus and methods for tunneling a media streaming application through a firewall

(76) Inventor: Wai Yim, San Jose, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/108,395

(22) Filed: Apr. 18, 2005

(51) Int. Cl. G06F 15/16

(52) U.S. Cl. 709/217

(57) ABSTRACT

When transmitting multimedia data associated with a multimedia application, a TCP/IP connection is established between a client application and a server application. UDP data is intercepted at an application level from one or more UDP data ports and channeled into one or more tunneling TCP data connections. TCP data is intercepted at the application level from one or more TCP data ports and re-directed to a tunneling TCP port. The channeled UDP data is received and dispatched to one or more local UDP data ports. Re-directed TCP data is received and then further re-directed to one or more local TCP data ports.

### CROSS REFERENCE TO RELATED APPLICATIONS

This application is related to U.S. patent application Ser. No. 10/681,523, entitled METHOD AND APPARATUS FOR TUNNELING DATA THROUGH A SINGLE PORT, filed on Oct. 8, 2003, and U.S. patent application Ser. No. 11/073,063, entitled MULTI-CHANNEL TCP CONNECTIONS WITH CONGESTION FEEDBACK FOR VIDEO/AUDIO DATA TRANSMISSION, filed on Mar. 3, 2005. Each of these applications is herein incorporated by reference in their entirety for all purposes.

### BACKGROUND OF THE INVENTION

The present invention relates generally to the transmission of information across the Internet, and more specifically to methods, systems, and apparatus for rapid, real-time streaming of data over the Internet and within networks and networked systems.

Many Internet based applications provide and exchange real-time streaming of data for effective implementation. By way of example, H.323 Internet video conferencing provides rapid, real time data exchange to present video and audio data for participants in local and remote settings. Typically, to realize the benefits of necessary real-time media streaming, data is transmitted using unreliable User Datagram Protocol/Internet Protocol (UDP/IP, or simply UDP). The advantage of using the unreliable UDP over the reliable Transmission Control Protocol (TCP, also TCP/IP) is primarily an advantage of speed. UDP has less overhead since it does not transmit packet acknowledgement, packet verification, packet re-transmission requests, etc. In real time media streaming, such transmissions and verification processes negatively impact system performance.

TCP is the dominant transport layer protocol of the current Internet. TCP maintains the highest degree of reliability by ensuring all data is received, received in the correct order, and that the data received is accurate and consistent with the data that was transmitted. In many applications, such reliability is paramount for effective communication and data exchange.

It would be desirable if streaming media, i.e., video and audio streams, could be carried over TCP connections because TCP is widely accepted by most industrial and consumer firewalls. TCP streams are also known to be friendlier to network security than UDP streams.

One of the most common problems regarding H323 applications, however, in connecting to another H.323 client or H.323 conference server from an office or home network is that most of these sites are protected by a firewall. A firewall is typically designed to keep out unwanted IP traffic from a protected network. However, the H.323 protocol requires a large number of TCP and UDP ports to be unblocked in order for it to work properly (e.g., all UDP ports from 1024-65538 need to be unblocked). Opening so many ports compromises the security of the local network, and is usually therefore not permitted by the typical firewall.

One solution is to install a special firewall that works with, or is at least friendly to H.323 protocol. Unfortunately, not many sites have this type of firewall. On the other hand, most firewalls (if not all) do open an HTTP (hyper text transfer protocol) port for generic web browsing. An HTTP port, in effect, is a TCP connection on port 80.

In view of the foregoing, what is needed is an H.323 application that channels all of its data through TCP port 80 connections only so that the application will be able to communicate with another H.323 application that implements the same channeling mechanism outside of the firewall.

### SUMMARY OF THE INVENTION

Broadly speaking, the present invention fills these needs by providing methods and apparatus to utilize standard HTTP/TCP (port 80) connections to tunnel the H.323 application data. The present invention can be implemented in numerous ways, including as a process, an apparatus, a system, a device, a method, or a computer readable media. Several embodiments of the present invention are described below.

In one embodiment, a method for transmitting multimedia data associated with a multimedia application is provided. The method includes establishing a TCP/IP connection between a client application and a server application. The method then provides for channeling a UDP data connection into a tunneling TCP data connection, and re-directing a TCP data connection to a tunneling TCP port. The re-directing includes intercepting the TCP data connection and re-directing the TCP data connection from a locally called TCP port through the tunneling TCP port. The method further provides for receiving the channeled UDP data connection and dispatching the UDP data connection to a local UDP data port. Additionally, the re-directed TCP data connection is received and the TCP data connection is then re-directed to a local TCP data port.

In another embodiment, a method of transmitting data is provided. The method includes intercepting a data stream at an application level of a client system, and directing the intercepted data stream to a tunneling port. The intercepted data stream is forwarded to a TCP/IP driver through the tunneling port.

In a further embodiment, a system for transmitting multi-media data across the Internet is provided. The system includes a first computing system configured to transmit a multi-media data stream. The multi-media data stream is transmitted through a tunneling port. The system further includes a second computing system configured to receive the multi-media data stream through the tunneling port. The first computing system intercepts UDP data and channels the UDP data through a tunneling TCP data port. The first computing system further intercepts TCP data and re-directs the TCP data to a tunneling TCP data connection. The second computing system receives the channeled UDP data through the tunneling TCP data port, and receives the re-directed TCP data stream through the tunneling TCP data connection.

In yet an additional embodiment, a communication protocol for enabling multi-media communication between computing devices is provided. The communication protocol provides at an application level configured to open a TCP data port for transmitting TCP data and further configured to open a UDP data port for transmitting UDP data, a WinSockProxy dynamic linked library. The WinSockProxy dynamic linked library is configured to intercept the TCP data transmitted in the TCP data port and to re-direct the TCP data to a tunneling TCP data port. The WinSockProxy dynamic linked library is further configured to intercept the UDP data transmitted in the UDP data port and to channel the UDP data into another tunneling TCP data port.

The advantages of the present invention over the prior art are numerous. One notable benefit and advantage of the invention is performance. In some data transmission approaches, all UDP and TCP data is channeled into a single TCP connection. The embodiments described herein alleviate network congestion relative to channeling into a single TCP connection. For example, when all data is channeled through a single TCP connection, retransmission of just one TCP/IP packet will delay the rest of the data in the channeling TCP connection. Embodiments of the present invention provide multiple TCP channels. If there is retransmission in one channeling TCP connection, data still flows through the others.

Another benefit is flexibility. In a configuration implementing a single TCP channeling connection, an application must multiplex data into a single channeling connection. In embodiments of the present invention, the channeling TCP connections are separated into 2 types: UDP-based and TCP-based channeling connections. For UDP-based channeling connections, there is a pool of one or more TCP channeling connections sharing all UDP traffic. For TCP connections, however, each connection is mapped, tunneled, and/or redirected, one-to-one, from the originally intended TCP port to the tunneling port (e.g., Port 80). Therefore, if the application makes additional TCP connections to the peer/server, the new data stream will not affect or interfere with the other channeling connections, except in the impact on overall network bandwidth usage.

Other advantages of the invention will become apparent from the following detailed description, taken in conjunction with the accompanying drawings, illustrating by way of example the principles of the invention.

### BRIEF DESCRIPTION OF THE DRAWINGS

The accompanying drawings, which are incorporated in and constitute part of this specification, illustrate exemplary embodiments of the invention and together with the description serve to explain the principles of the invention.

FIG. 1 is a simplified schematic diagram illustrating a typical H.323 TCP/UDP connection sequence.

FIG. 2 is a high level schematic of data flow between a client and a server in accordance with one embodiment of the present invention.

FIG. 3 illustrates the communication path between an H.323 client and an H.323 server in accordance with one embodiment of the invention.

FIG. 4 shows the relative positioning and content of the WinSockProxy.dll module in accordance with one embodiment of the invention.

FIG. 5 shows data flow between an H.323 client and an H.323 server in accordance with one embodiment of the present invention.

FIG. 6A is a table that describes the data fields of a connection header in accordance with one embodiment of the present invention.

FIG. 6B is a table that describes the data fields of a tunneling header in accordance with one embodiment of the present invention.

FIG. 6C is a table illustrating an exemplary byte stream of tunneling data in accordance with one embodiment of the present invention.

FIG. 7A is a logic flowchart diagram illustrating the logic flow of the socket: bind operation of the WinSockProxy.dll in accordance with one embodiment of the present invention.

FIG. 7B is a logic flowchart diagram illustrating the logic flow of the socket: connect operation of the WinSockProxy.dll in accordance with one embodiment of the present invention.

FIG. 7C is a logic flowchart diagram illustrating the logic flow of the socket: send to operation of the WinSockProxy.dll in accordance with one embodiment of the present invention.

FIG. 7D is a logic flowchart diagram illustrating the logic flow of the socket: recvfrom operation of the WinSockProxy.dll in accordance with one embodiment of the present invention.

FIG. 7E is a first sheet of a logic flowchart diagram illustrating the logic flow of the socket: select operation of the WinSockProxy.dll in accordance with one embodiment of the present invention.

FIG. 7F is the continuation of the logic flowchart diagram of FIG. 7E in accordance with one embodiment of the present invention.

FIG. 7G is a logic flowchart diagram illustrating the logic flow of the socket: accept operation of the WinSockProxy.dll in accordance with one embodiment of the present invention.

FIG. 7H is a logic flowchart diagram illustrating the logic flow of the socket: getpeername operation of the WinSockProxy.dll in accordance with one embodiment of the present invention.

FIG. 71 is a logic flowchart diagram illustrating the logic flow of a background listening operation of the WinSockProxy.dll in accordance with one embodiment of the present invention.

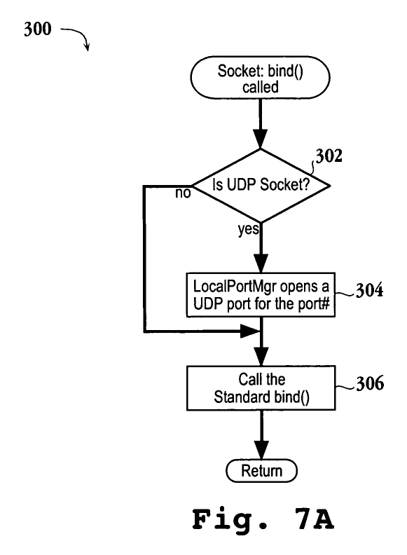

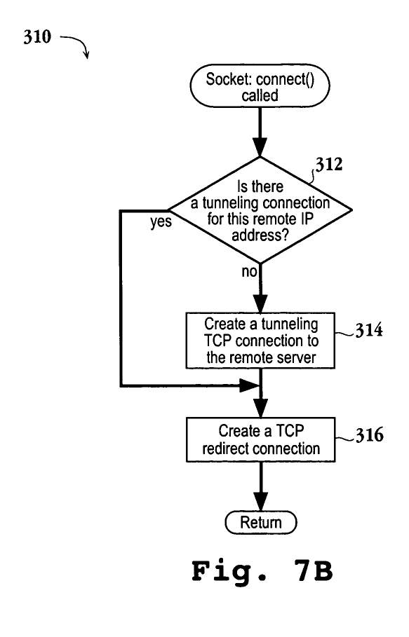

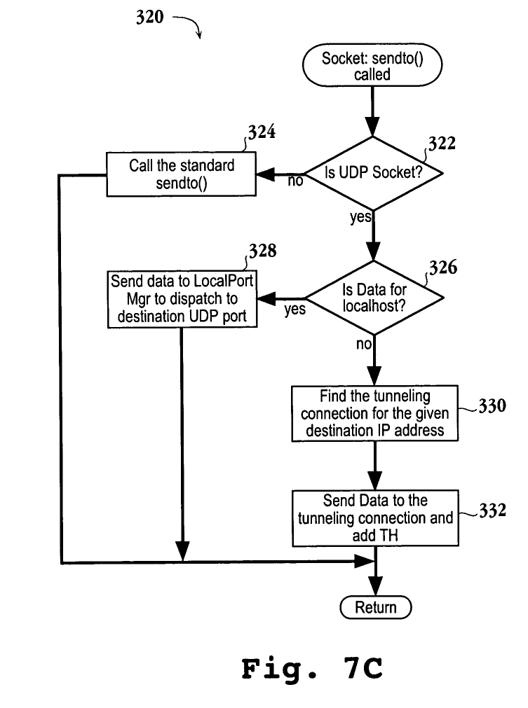

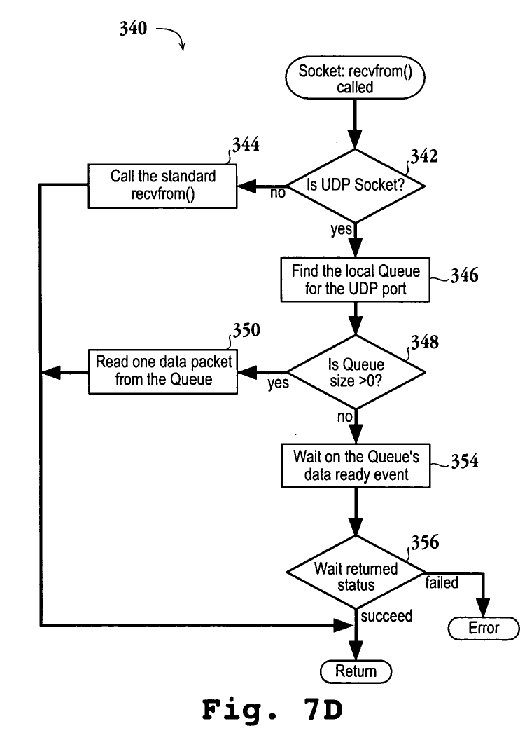

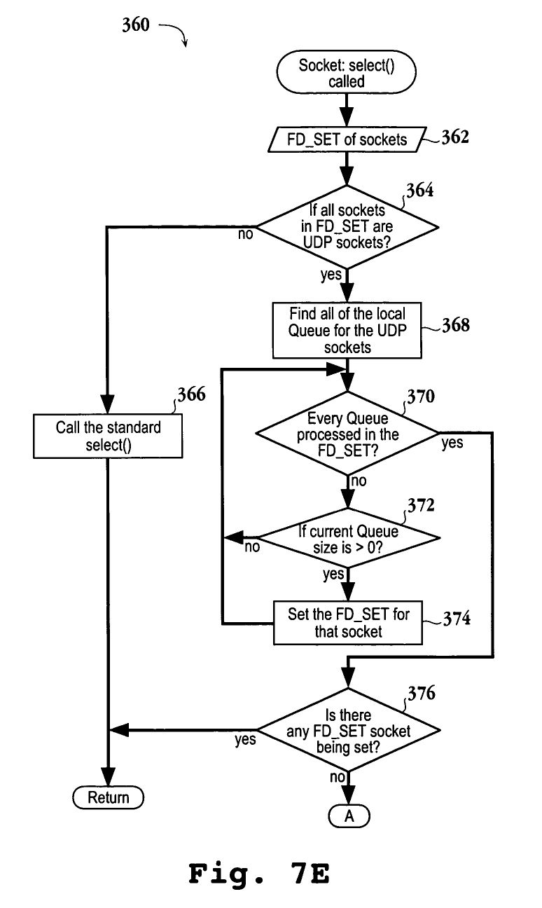

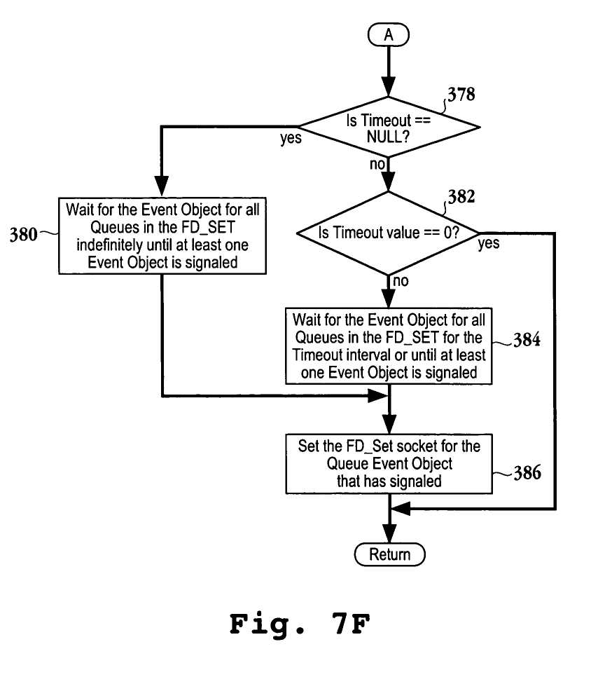

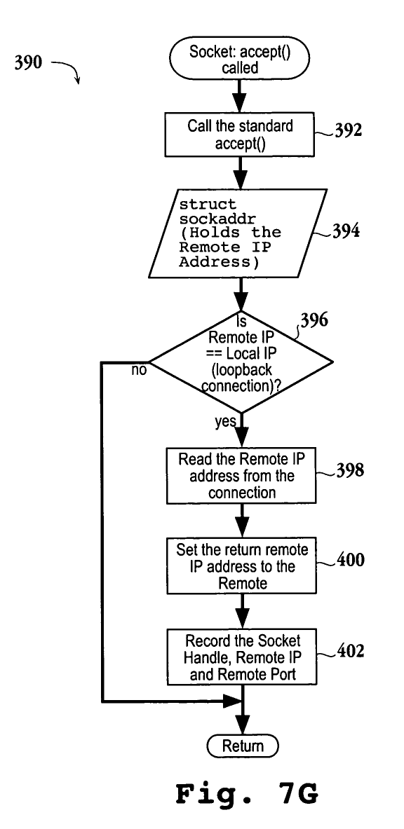

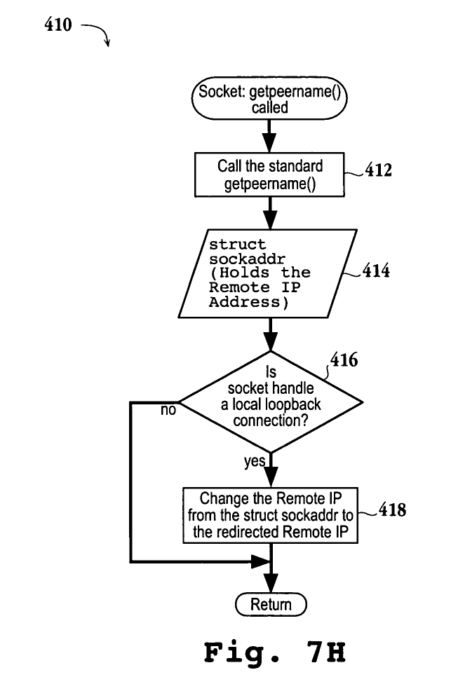

FIG. 7J is a logic flowchart diagram illustrating the logic flow of a TCPRedirectMgr function of the WinSockProxy.dll in accordance with one embodiment of the present invention.

FIG. 8A is a high level schematic showing the dispatching of UDP tunneling data using locally opened UDP ports in accordance with one embodiment of the present invention.

FIG. 8B is a detail view of the server side of the dispatching of UDP tunneling data using locally opened UDP ports illustrated in FIG. 8A.

### DETAILED DESCRIPTION OF THE PREFERRED EMBODIMENTS

An invention for utilizing standard HTTP/TCP (port 80, generally referred to herein as TCP port 80) connections to channel H.323 application data is provided. In preferred embodiments, the present invention shields much of the channeling details from the H.323 application itself. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

Broadly speaking, embodiments of the present invention are implemented by tunneling all H.323 TCP/UDP port traffic through multiple HTTP (or HTTPS)/TCP connections. In related and currently co-pending U.S. Patent applications, approaches are disclosed in which, for example, data is tunneled through a single HTTP port in order to pass through a firewall configured to limit the number of unblocked ports for transmitting data as described in above-identified co-pending U.S. patent application Ser. 10/681,523, the disclosure of which is incorporated herein by reference for all purposes. Another approach uses multiple tunneling TCP connections and is described in above-identified co-pending U.S. patent application Ser. No. 11/073,063, the disclosure of which is also incorporated herein by reference for all purposes.

In these related applications, approaches are disclosed in which, generally, implementation is achieved at the device driver or kernel level. Embodiments of the present invention, generally, are implemented at the application level. Embodiments of the present invention provide for implementation by integration of the tunneling mechanism with existing H.323-based applications by abstracting the tunneling implementation into a proxy socket library which layers on top of the traditional socket library. Further, the invention simplifies the implementation of the H.323 data tunneling by, in one embodiment, combining into a single HTTP/TCP connection all H.323 UDP data, and implementing an HTTP/TCP connection redirect for each H.323 TCP connection. In another embodiment, all H.323 UDP data is channeled into multiple HTTP/TCP connections.

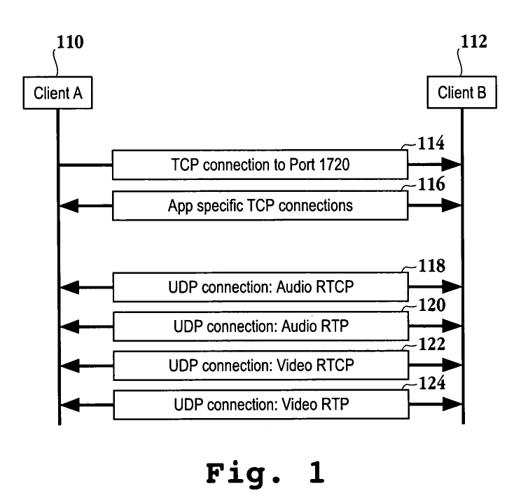

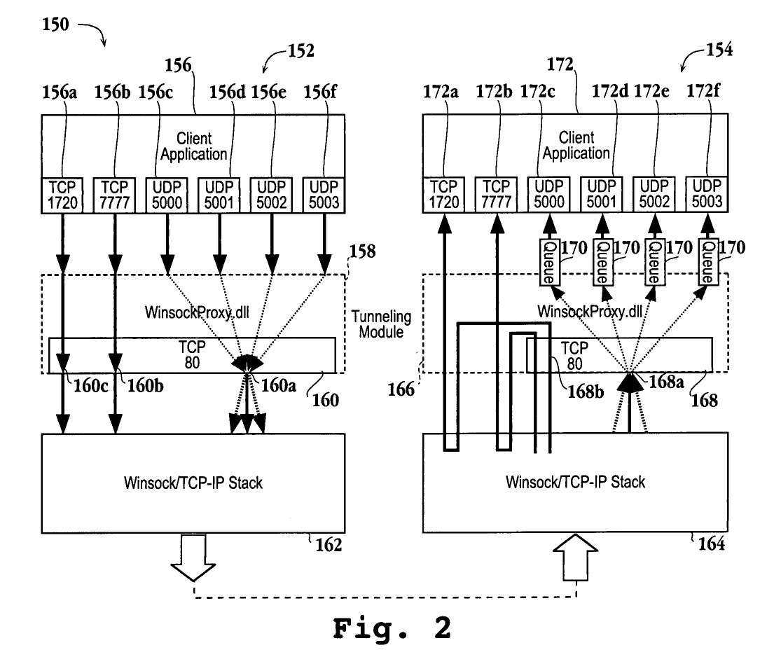

Usually, an H.323 application establishes a TCP connection with another H.323 application that is listening on TCP port 1720. In subsequent data exchange, both applications open up more TCP and UDP ports for control data and media data transmission, such as, for example, streaming media. FIG. 1 is a simplified schematic diagram illustrating a typical H.323 TCP/UDP connection sequence. As illustrated in FIG. 1, an H.323 application initiates a TCP/IP connection to another H.323 application that is listening on TCP port 1720. For example, client A 110 requests a TCP connection to port 1720 through transmission 114 to client B 112. Application specific TCP connections, such as setup and call control transmissions 116, proceed over reliable, TCP connections. Subsequent data exchanges are represented by connections 118, 120, 122, and 124, which are intended to be representative of any number of connections that may be established. By way of example, media streaming (e.g., real-time and other audio and video data) may utilize UDP ports and protocol, and such connections might be established for audio real-time control packets, 118, audio real-time packets 120, video real-time control packets 122, and video real-time packets 124, etc. During the typical connection sequence, the H.323 application writes data into an open socket (either TCP or UDP), and the Winsock32.dll module passes this data to the TCP/IP driver.

As is generally known, Winsock32.dll is a dynamic link library, which is a collection of small programs, any of which may be called when needed by a larger program that is running on the computer, such as an H.323 video conferencing program. One version of the dynamic link library is known as Winsock.dll. The terms “Winsock.dll” and “Winsock32.dll” are used interchangeably throughout this document.

In one embodiment of the present invention, an inventive dynamic linked library (WinSockProxy.dll) module is inserted between the H.323 application and the traditional Winsock.dll/TCP-IP Stack. This WinSockProxy.dll module implements all of the APIs (Application Programming Interface) normally implemented by the traditional Winsock.dll. In one embodiment, the WinSockProxy.dll intercepts all of the socket API calls from the H.323 application(s) and performs TCP port 80 (i.e., HTTP) tunneling. As a result, embodiments of the present invention require no modification of the application's code.

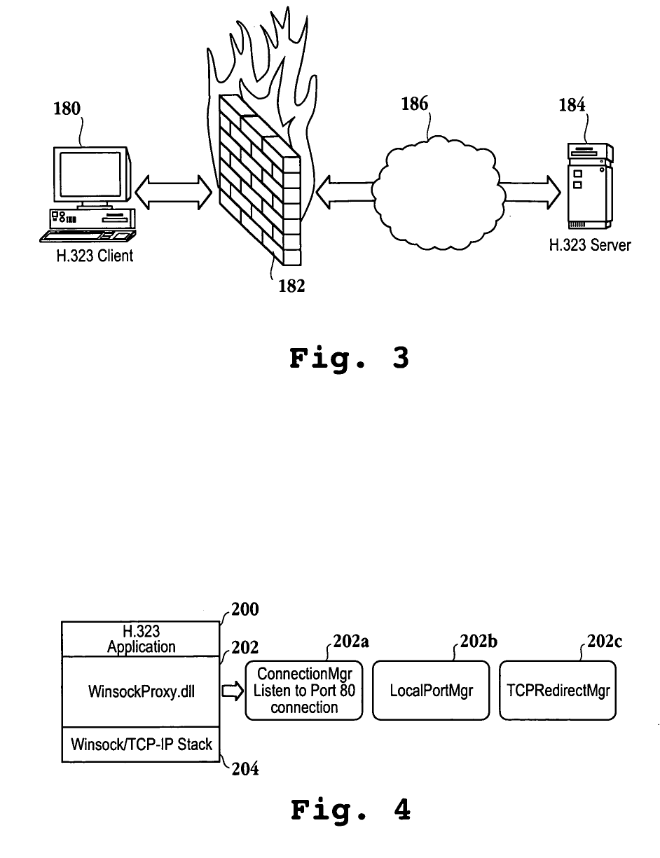

FIG. 2 is a high level schematic 150 of data flow between a client 152 and a server 154 in accordance with one embodiment of the present invention. The following description of high level schematic 150 provides a general overview of data processing and flow in accordance with one embodiment of the present invention. In one embodiment, the client 152 initiates all connections to the server 154. As illustrated in FIG. 2, an exemplary H.323 client application 156 opens TCP ports 1720 and an application specific TCP port 7777, shown at 156a and 156b, respectively, and a plurality of UDP ports 156c-156f. All of the process operations for data transmission (i.e., socket API calls) from client H.323 application 156 are intercepted by WinSockProxy.dll 158 where data is channeled over TCP port 80 connection(s), shown at 160. Each TCP data stream is redirected to TCP port 80, shown at 160c and 160b, and UDP data from each of the plurality of UDP ports 156c-156f is channeled into a single TCP tunneling connection on TCP port 80 at UDP tunneling mux 160a. In one embodiment, UDP data from the plurality of UDP ports 156c-156f is channeled into a plurality of TCP tunneling connections on TCP port 80 at UDP tunneling mux 160a. Client Winsock/TCP-IP Stack 162 transmits all of the data as regular TCP port 80 connection data, and server Winsock/TCP-IP Stack 164 receives all of this TCP tunneling port 80 traffic.

On the server side, server Winsock/TCP-IP Stack 164 receives all of the channeled tunneling TCP data on TCP port 80, 168, and forwards the data to the server H.323 application 172 as appropriate. The channeled tunneling TCP data is intercepted by WinSockProxy.dll 166. The intercepted TCP data that was originally transmitted by client H.323 application 156 as TCP data for a different TCP port is re-directed, shown at TCP re-direct 168b within TCP port 80, 168, to the appropriate local TCP port, and thereby routed back through the server Winsock/TCP-IP Stack 164, and on to the intended TCP port 172a and 172b of server H.323 application 172. The intercepted TCP data that was originally sent as UDP data is returned to its original UDP data state at UDP tunneling de-mux 168a and in the illustrated embodiment is dispatched to the plurality of local UDP ports 172c-172f opened by server H.323 application 172. In one embodiment, UDP queues 170 are formed for each of the UDP ports 172c-172f, and UDP data packets added to the queues 170 as appropriate. In another embodiment, the UDP queues are replaced with additional, locally opened UDP ports. The tunneled UDP data is sent from these locally opened UDP ports to the H.323 application's UDP ports.

As described above, one embodiment of the present invention provides for tunneling media streams in a firewall environment. The environment described in a typical connection sequence includes a firewall in a communication path between an H.323 client and an H.323 server, and the H.323 client resides inside of (also known as residing “behind”) the firewall. The H.323 client initiates a TCP connection to an H.323 server outside the firewall. FIG. 3 is provided to illustrate the communication path between an H.323 client 180 and an H.323 server 184 in accordance with one embodiment of the invention. As illustrated, the H.323 client 180 resides inside of firewall 182, and accesses H.323 server 184 over the Internet 186, or any network. It should be appreciated that H.323 server 184 can be any other H.323 application including another H.323 client-like application, a video conferencing server application, and the like. For ease of illustration, the H.323 application 184 is referred to herein as an H.323 server 184 application.

Embodiments of the present invention include an inventive dynamic linked library module, WinSockProxy.dll, which is inserted between the H.323 application (both on the client side and on the server side) and the operating system (OS) Winsock.dll/TCP-IP stack. All of the tunneling operations described for embodiments of the present invention are accomplished by and within this WinSockProxy.dll module.

FIG. 4 shows the relative positioning and content of the WinSockProxy.dll module 202 in accordance with one embodiment of the invention. As described above, the WinSockProxy.dll module 202 is inserted between the H.323 application 200 and the OS Winsock/TCP-IP Stack 204. In one embodiment, the WinSockProxy.dll module 202 includes a Connection Manager 202a, a Local Port Manager 202b, and a TCP Redirect Manager 202c. Each of the components of the WinSockProxy.dll module 202 is described in the following paragraphs.

In one embodiment of the present invention, the primary function of the ConnectionMgr component 202a is to handle incoming connection requests for the tunneling port, which is port 80 in this example. There are generally two types of TCP connections for the tunneling port: 1) A tunneling connection for the UDP data; and 2) a redirecting connection for the TCP data.

After the ConnectionMgr 202a has accepted a connection request, it will read the first block of data to determine the type of connection. If it is a tunneling connection for the UDP data, one embodiment of ConnectionMgr 202a creates a thread, called PacketDispatcher, which handles all of the data passing through this connection. PacketDispatcher reads all of the incoming data and communicates with the LocalPortMgr component 202b to dispatch the data to the proper queue based on the intended destination UDP port for the data.

In one embodiment, LocalPortMgr 202b maintains a list of queue objects, also referred to herein as “queues,” for each UDP port the H.323 application binds to. One queue is created for each UDP port. These queues are dedicated to incoming data, in one embodiment of the invention. In another embodiment, a queue is created and maintained for both incoming and outgoing data buffering, and in another embodiment, a separate queue is created and maintained for each port for outgoing data. In one embodiment, this queue is a traditional local memory allocated queued data object, i.e., “queue,” or another locally bound UDP port that transfers UDP data to a single UDP port opened by the H.323 application.

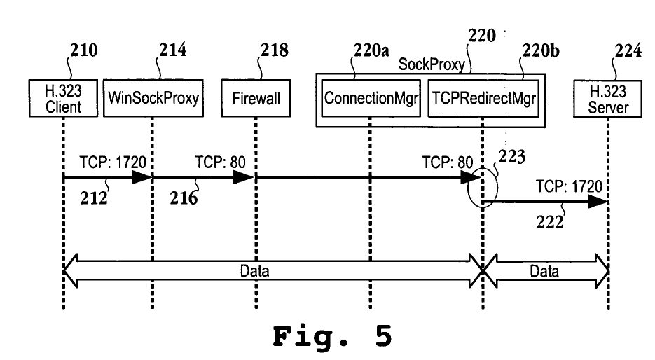

If the connection request received by the ConnectionMgr 202a is for a redirecting TCP connection, ConnectionMgr 202a passes the connection request to the TCPRedirectMgr component 202c. In one embodiment, the TCPRedirectMgr 202c creates a local TCP connection on behalf of the incoming connection to the intended local TCP port. It should be appreciated that the existing TCP/IP mechanism of the OS operates such that once a request for a TCP connection has been made, the application is unable to affect the point or location of the TCP connection. As a result, embodiments of the present invention provide a mechanism to make another, distinct, connection to the local TCP port and transmit the data between the tunneling connection and the local connection. The TCPRedirectMgr 202c, in one embodiment, transfers all data between the tunneling and local connections, as shown at junction 223 in FIG. 5. In one embodiment of the present invention, TCPRedirectMgr 202c accepts incoming tunneling TCP connections from ConnectionMgr 202a. TCPRedirectMgr 202c creates a local TCP connection to the intended local TCP port. Then, the TCPRedirectMgr 202c transfers data between the tunneling and local connections, effecting a two-way or bi-directional data transfer.

FIG. 5 illustrates the function of the TCPRedirectMgr 202c in which an H.323 client makes a TCP connection to port 1720 of an H.323 server in accordance with one embodiment of the invention. An H.323 client 210 makes a TCP connection 212 to port 1720 of H.323 server 224. WinSockProxy.dll 214 intercepts the socket function calls from the H.323 client 210 application. WinSockProxy.dll 214 changes the original destination port number of the H.323 client from port 1720 to port 80, shown at 216. On the H.323 server side, the ConnectionMgr 220a is awaiting incoming tunneling TCP connections on its local TCP port 80. Once the tunneling TCP connection is established between the H.323 client 210 and the H.323 server 224, the WinSockProxy.dll 214 on the H.323 client side sends a tunneling specific block of information to the WinSockProxy.dll 220 on the H.323 server side that details which local TCP port the tunneling TCP connection is originally intended from the H.323 client 210.

After the WinSockProxy.dll 220 on the H.323 server side has received this information, ConnectionMgr 220a forwards the request and information to the TCPRedirectMgr 220b. The TCPRedirectMgr 220b creates a new TCP connection to the locally intended TCP port, in this case, port 1720, shown at 222. After the connection is established, the WinSockProxy.dll 220 returns the socket handle to the H.323 client 210 application where the H.323 client 210 application will send and receive data as usual without knowing the connection has been redirected to port 80. In one embodiment, the TCPRedirectMgr 220b has a dedicated thread that transfers data between the tunneling TCP connection and the local TCP connection, as illustrated in FIG. 5, at junction 223. The H.323 server 224 application also has a thread that will receive a new connection request for TCP port 1720. However, during the socket accept( ) function call, the WinSockProxy.dll 220 replaces the incoming connection remote system (the H.323 client 210) IP address from local IP to the remote system local IP address. This information is sent to the WinSockProxy.dll 220 on the H.323 server side from the H.323 client side WinSockProxy.dll 214 during the first block of tunneling data. In one embodiment, the TCPRedirectMgr 220b does not modify, insert, or remove any data that it reads or writes from either of the two TCP connections, except the first block of tunneling header information. In this embodiment, the TCPRedirectMgr 220b transfers the data between the tunneling and the local connections at junction 223.

Looking again at FIG. 2, in one embodiment of the present invention, the H.323 client 156 creates a TCP port 1720 156a connection to the H.323 server 172 before the H.323 client 156 and the H.323 server 172 start sending UDP data to each other. As is known, any H.323 application may establish other TCP connections to the H.323 server 172 before the H.323 client 156 makes the TCP port 1720 156a connection. However, one characteristic of H.323 data exchange is that there will generally always be one TCP connection to the H.323 server 172 before UDP data is sent.

Embodiments of the present invention exploit this characteristic of H.323 data exchange. A table is created to track and manage the number of TCP connections to a given unique remote IP address. When the very first TCP connection request is made to a remote IP, in the present example the IP of the server H.323 application 172, the WinSockProxy.dll 158 will create, in one embodiment, a tunneling TCP connection to the remote IP, and in another embodiment, multiple tunneling TCP connections. When the last regular (non-tunneling) TCP connection to this remote IP is closed (i.e., by the client application 156), the WinSockProxy.dll 158 will close the tunneling TCP connection or connections for that remote IP. It should be appreciated that, when the client closes the connection or connections, the server will know the socket (or TCP connection) has been closed by the remote side (H.323 client). As a result, the WinSockProxy.dll on the H.323 server side will initiate a cleanup, closing the connection or connections on the server side.

In typical H.323 data exchange, there are 2 types of connections: the TCP connections and the UDP connections. In embodiments of the present invention, for UDP connections, all data is sent and received using a single tunneling TCP connection in one embodiment, and using multiple tunneling TCP connections in another embodiment. For TCP connections, i.e., data that is originally and normally transmitted using TCP, there is no channeling of multiple TCP connection data into one or more connections. Instead, each TCP connection that is opened for TCP data maintains its own connection identity or characteristic. Embodiments of the present invention provide for the original TCP connection data to be transparently sent to the tunneling TCP port.

As described above, the WinSockProxy.dll, in embodiments of the present invention, provides for creating tunneling connections for UDP data and transparently redirecting TCP connections to a different and dedicated TCP tunneling port (e.g., TCP port 80 in the exemplary embodiments described herein). For tunneling UDP data, the WinSockProxy.dll inserts an individual, specialized tunneling header in front of each UDP data block with information including the original destination UDP port for which the UDP data is originally intended. Additionally, in one embodiment, the type of tunneling connection is identified by the first block of tunneling header information, as described in greater detail below.

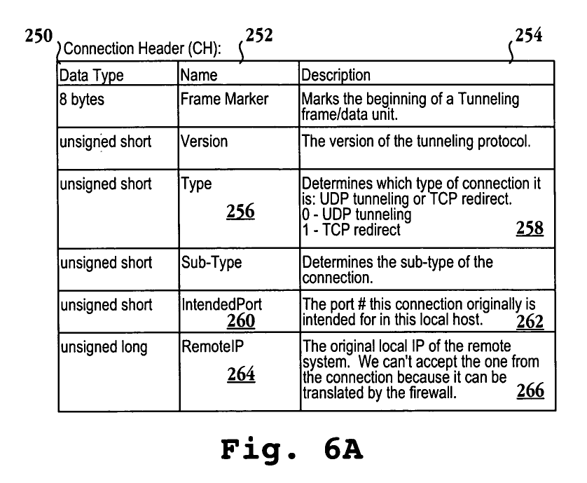

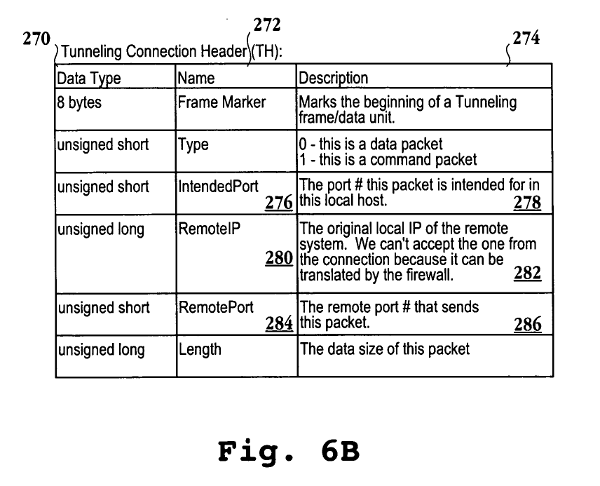

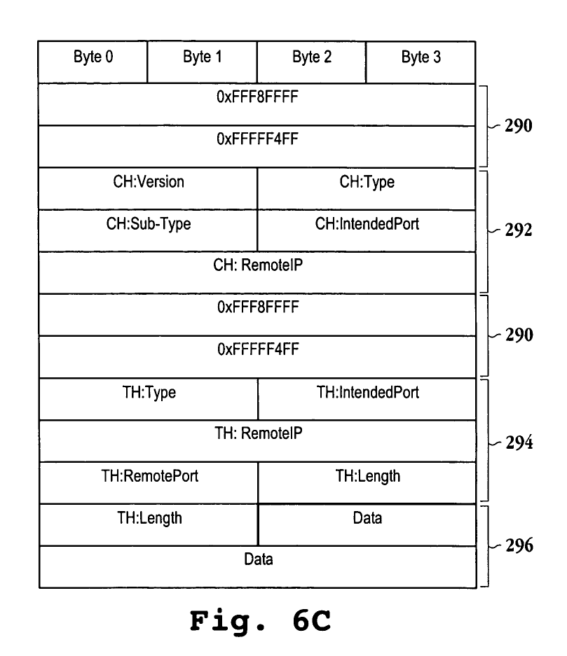

As described above in reference to FIG. 4, the ConnectionMgr 202a distinguishes between the two types of tunneling TCP connections: 1) a UDP tunneling connection, and 2) a TCP redirecting connection. When the ConnectionMgr 202a accepts a connection, it reads a first block of data of predefined length from the tunneling TCP connection as the tunneling header information. This tunneling header includes such information as the originally transmitted destination port, and other information as described below. In one embodiment of the invention, the first block of information from the tunneling TCP connection is an 20-byte connection header. FIG. 6A is a table that describes the data fields of a connection header in accordance with one embodiment of the present invention.

The table of connection header fields shown in FIG. 6A describes a data field in each row, with columns identified for the data type 250, the name of the data field 252, and a brief description of the data field 254. Of particular note in FIG. 6A is the data field of the connection header that identifies the type of connection 256, described as identifying the connection type as either a UDP tunneling connection or a TCP redirect connection, as shown at 258. In one embodiment, another data field of the connection header is the IntendedPort field 260. The IntendedPort data field 260 is described as identifying the port number the connection is intended for in the local host, as shown at 262. Further, the connection header includes the RemoteIP data field 264. As shown, the RemoteIP data field 264 identifies the original local IP of the remote system. It is emphasized that the RemoteIP data field 264 is necessary since the connection-identifying information will reflect an IP that may have been translated by a firewall in data field 266.

As shown in FIG. 6A, the connection header identifies, among other attributes, the type of connection as either UDP tunneling, or TCP redirect, 256, 258. For TCP redirect connections, all data after the connection header is essentially regular or typical application data, and is passed through to a local loopback connection. For UDP tunneling connections, all data will be encapsulated in a tunneling header.

FIG. 6B is a table that describes the data fields of a tunneling header in accordance with one embodiment of the present invention. FIG. 6B presents the data fields just as presented in FIG. 6A with each row describing a data field, and each column describing the data type 270, the name of the data field 272, and a brief description of the data field 274. The data fields themselves are easily understood by one of ordinary skill in the art. Of particular note, the intended port data field 276 identifies the port number for which the data packet is intended in the local host 278. Further, the RemoteIP data field 280 identifies the original local IP of the remote system 282. As described above in relation to the connection header of FIG. 6A, the connection-identifying information may not identify the correct local IP of the remote system due to translation that may occur at a firewall, network address translation (NAT) router, etc. Similarly, data field RemotePort 284 identifies the remote port number that sends the data packet, as described in data field 286.

In one embodiment of the present invention, there are 8 bytes of 0×FFF8FFFF, and 0×FFFFF4FF provided before the tunneling packet block as a delimiter. The delimiter helps in determining a location of the packet boundary. The tunneling data packet is transmitted using a TCP connection, and the intended result is that all data sent is received. However, an embodiment of the present invention provides a modicum of insurance by identifying the packet boundary in this manner. Without a delimiter, and if the data stream is corrupted for any reason, there is no way of recovering the data since the offset for the tunneling header will be incorrect. Embodiments of the present invention provide that if a corrupted data packet does enter the data stream, the packet boundary can be readily and easily identified to recover the data, and then the remaining data can continue to be read.

It should be appreciated that the embodiments illustrated in FIGS. 6A and 6B are exemplary data fields for the connection (FIG. 6A) and tunneling (FIG. 6B) headers. Other embodiments may utilize different fields, or may arrange the data in varying manners. The embodiments illustrated in FIGS. 6A and 6B should therefore not be interpreted to be exclusive or limiting, but rather exemplary or illustrative.

In one embodiment of the present invention, data transmitted according to the present invention present a byte stream with a connection header and a tunneling header (for UDP data packets) before the actual data of the data stream. FIG. 6C is a table illustrating an exemplary byte stream of tunneling data in accordance with one embodiment. The exemplary byte stream includes 8 bytes of delimiter 290, 12 bytes of the connection header 292 as described in reference to FIG. 6A, 8 bytes of delimiter 290, 14 bytes of tunneling header 294 as described above in reference to FIG. 6B, and the data 296. It should be appreciated that TCP redirect data would include the delimiters 290 and the 12 bytes of the connection header 292, but would not include the 14 bytes of the tunneling header 294. As described above in detail, the TCP redirect is, in one embodiment, TCP connection data that has been appended with a connection header 292 and transmitted using HTTP port 80, for example. The TCP data received via the tunneling port is then redirected by the server WinSockProxy.dll to the originally intended TCP port. In contrast, UDP data is channeled into a single TCP connection, in one embodiment, or channeled into multiple TCP connections in another embodiment, using the tunneling HTTP (TCP) port 80, and therefore the additional tunneling header 294 is used for UDP data transmitted as a TCP tunneling data stream.

In addition to dispatching incoming tunneling connections to the appropriate handling module, one embodiment of the present invention provides for the ConnectionMgr to perform the function of remote peer IP address collision management. As is known, each H.323 connection to an H.323 server requires a unique and consistent IP address for each H.323 client. In an environment where there is no firewall or NAT intervening between clients and servers, all of the client IP addresses are unique and consistent. A server can easily identify each H.323 client by the unique IP address. However, when firewalls, NATs, or other similar devices exist between H.323 clients and H.323 servers, IP address duplication can occur, a condition known as IP address collision. A typical example is the situation in which two H.323 clients connect to an H.323 server from behind the same firewall/NAT. The H.323 server will see two H.323 connection requests with the same IP address (e.g., the firewall/NAT IP address). In one embodiment of the present invention, a pair of IP addresses from each incoming tunneling connection is recorded or maintained and monitored: 1) the IP address from the Internet connection (e.g., the firewall/NAT IP address), and 2) the local H.323 client IP address (e.g., the local IP address within the local network protected by the firewall/NAT). In one embodiment, this pair is unique.

In one embodiment of the present invention, when the ConnectionMgr receives a new tunneling connection, the connection network IP (which may be the firewall/NAT IP address) is retrieved, and the IP address is paired with the local IP address that is sent from the remote client (i.e., from the connection header). Using this IP address pair, the ConnectionMgr searches all existing tunneling connections to determine if the same IP address pair already exists. If there is a match, i.e., if the IP pair has already been mapped indicating that data is already being processed from the same remote peer now transmitting this new or additional tunneling connection, the ConnectionMgr will get the assigned IP address from the existing tunneling connection(s) for this new incoming tunneling connection to use for the application. If there is no match, the ConnectionMgr then searches all of the existing tunneling connections with the same remote peer local IP address. If there is no match, ConnectionMgr creates a new IP address (called the mapped IP) to be used by the application. In this case, since there is no conflict, one embodiment of the invention provides for the remote peer's local IP address to be passed on to the application as the remote peer's IP address, known to the ConnectionMgr as the mapped IP address. However, if there is another connection with the same mapped IP address, there is an IP address collision. In an IP address collision, the ConnectionMgr generates a random IP address not in use. In one embodiment, the ConnectionMgr then assigns this newly (and randomly) generated IP address to the new connection as the mapped IP address.

Additionally, IP address collision can occur if the remote peer local IP address is the same as the local IP address of the server. In this situation, one embodiment of the present invention provides that the ConnectionMgr randomly generates a new mapped IP address for the new incoming tunneling connection.

Two examples of IP address collision management in accordance with embodiments of the present invention are illustrated.

### EXAMPLE 1

Client 1 with IP address 192.168.0.5 behind firewall with IP 122.66.80.8 and Client 2 with IP address 192.168.0.5 behind firewall with IP 144.22.178.24, both connected to a Server with local IP address 192.168.0.2. After Client 1 is connected (and to the application, the mapped IP is 192.168.0.5), Client 2 tries to connect to the server. However, at this time, the Client 2 local IP 192.168.0.5 is already in use by Client 1. Accordingly, the ConnectionMgr at the server generates a new random unique IP address for Client 2 as the mapped IP, e.g., 178.22.16.20. This will be the mapped IP that gets passed to the application.

### EXAMPLE 2

Client 1 with IP address 192.168.0.5 behind firewall with IP 122.66.80.8 connects to a Server with IP address 192.168.0.5. In this case, even though there are no other tunneling connections, the server can't accept the remote client's local IP address as the mapped IP because it conflicts with the server's own local IP address. Therefore the ConnectionMgr randomly generates a new unique IP address as the mapped IP address for this connection.

As described above in detail, in one embodiment of the invention, when the H.323 application starts up and loads the WinSockProxy.dll module, the WinSockProxy.dll creates the three components shown in FIG. 4: the ConnectionMgr 202a, the LocalPortMgr 202b, and the TCPRedirectMgr 202c. The WinSockProxy.dll with the three components utilizes or calls a plurality of socket operations as well as enabling background listening on the tunneling port. The following diagrams illustrate the logic flow for exemplary and typical socket operations, as well as background listening operations on the tunneling port.

FIG. 7A is a logic flowchart diagram 300 illustrating the logic flow of the socket: bind operation of the WinSockProxy.dll in accordance with one embodiment of the present invention. The logic flow begins with the determination whether the bind called is for a UDP socket in decision block 302. If the call is not for a UDP socket, a “no” to decision block 302, the logic flow proceeds with operation 306 and calling the standard bind operation. If the socket called is a UDP socket, a “yes” to decision block 302, the logic flow first proceeds to operation 304 in which the LocalPortMgr component of the WinSockProxy.dll module opens a new or different UDP port for the called port number. This new or different UDP port opened by the LocalPortMgr is for dispatching data received from the tunneling connections to the application's original UDP port. Then, the logic flow proceeds with operation 306 and calling the standard bind operation. In one embodiment, the socket: bind operation is one that is performed by either or both of a client WinSockProxy.dll and a server WinSockProxy.dll.

FIG. 7B is a logic flowchart diagram 310 illustrating the logic flow of the socket: connect operation of the WinSockProxy.dll in accordance with one embodiment of the present invention. The socket: connect operation as illustrated, is generally called for TCP connections. In decision block 312, it is determined whether a tunneling connection already exists for the remote IP address. As described above in reference to FIG. 1, the H.323 initial handshake sequence typically begins or is initiated with a TCP connection to a remote peer/server. UDP data is transmitted following the initial handshake, being sent on different UDP ports. To improve efficiency, during the first TCP connection to a given remote peer/server, embodiments of the present invention create the tunneling connections for UDP data that will soon follow in the course of the successful H.323 connection. As described above, embodiments utilize as many TCP connections as the H.323 application opens for transmitting data. Each connection, however, is tunneled using HTTP (TCP) port 80, and then re-directed to a local TCP port number upon receipt at a server or recipient side. Therefore, if there is already a tunneling connection for the remote IP address, a “yes” to decision block 312, then the logic flow proceeds to operation 316 in which a TCP redirect connection is made. If there is no tunneling connection for the remote IP address, a “no” to decision block 312, one must be created and the logic flow continues with operation 314 in which a tunneling TCP connection, in one embodiment, or multiple TCP tunneling connections, in another embodiment, to the remote server is created. Following operation 314, the logic flow continues with operation 316 and creating a TCP redirect connection. The socket: connect operation as illustrated in FIG. 7B is essentially a client-side operation. As described above, once the redirect TCP connection is established, the WinSockProxy.dll sends out the tunneling header information to the remote side and indicates the original TCP port for which this TCP connection is intended.

FIG. 7C is a logic flowchart diagram 320 illustrating the logic flow of the socket: sendto operation of the WinSockProxy.dll in accordance with one embodiment of the present invention. The operation is alternatively known as socket: send. When the socket: sendto is called, it is first determined whether the call is for a UDP socket, shown at decision block 322. In one embodiment, if the call is not for a UDP socket, a “no” to decision block 322, the standard sendto is called in operation 324. If the call is for a UDP socket, a “yes” to decision block 322, the logic flow proceeds to decision block 326 in which it is determined whether the data is for a local host (localhost). If the data is for a localhost, a “yes” to decision block 322, the logic flow proceeds with operation 328 in which the data is sent to the LocalPortMgr component of the WinSockProxy.dll module to be dispatched to the local UDP ports through, in one embodiment, a local UDP port queue where a tunneling header block will be appended in front of the original data block with information such as remote IP and local IP address.

If the data is not for the localhost, in one embodiment, the data will be channeled into a single TCP tunneling connection on TCP port 80. In another embodiment, the data will be channeled into one or more of multiple TCP tunneling connections on TCP port 80. Therefore, in operation 330, the logic flow finds the tunneling connection for the given destination IP address. Next, in operation 332, the data is sent to the tunneling connection with tunneling header appended in front of the data block.

FIG. 7D is a logic flowchart diagram 340 illustrating the logic flow of the socket: recvfrom operation of the WinSockProxy.dll in accordance with one embodiment of the present invention. The socket operation is alternatively known as socket: recv. The logic flow first determines whether the call is for a UDP socket in decision block 342. If the call is not for a UDP socket, a “no” to decision block 342, the logic flow calls the standard recvfrom (recv). If the call is for a UDP socket, a “yes” to decision block 342, the logic proceeds with operation 346 in which the local queue for the UDP port is found. In one embodiment, operation 346 includes finding the local UDP port. Next, the local queue for the UDP port is examined in decision block 348 to determine whether there is data in the queue, i.e., the queue size is greater than zero. If there is data in queue, a “yes” to decision block 348, the logic flow proceeds with operation 350 in which a data packet is read from the queue.

If there is no data in queue, a “no” to decision block 348, the most likely cause is that the queue has not yet processed the data ready event. In operation 354, the logic flow provides for waiting for the queue's data ready event. Decision block 356 provides for determining the wait status. If the queue returns a data ready event, and therefore data is in queue to be read, a “succeed” response to decision block 356, the socket: recvfrom call is returned. If the queue does not return a data ready event, a “failed” response to decision block 356, an error is returned. However, in another embodiment of the invention, the LocalPortMgr uses dedicated UDP ports for data dispatching instead of local ports for data queues. In that embodiment, the recvfrom function calls the regular recvfrom function. The regular recvfrom will handle the read wait automatically. After the regular recvfrom returns the UDP data, LocalPortMgr strips the first block of the UDP data, i.e., the tunneling header information block, and uses that information to update the remote address.

FIG. 7E is a first sheet of a logic flowchart diagram 360 illustrating the logic flow of the socket: select operation of the WinSockProxy.dll in accordance with one embodiment of the present invention. In one embodiment, the method operations illustrated in FIG. 7E are applicable to an implementation in which LocalPortMgr implements data dispatching using one or more data queue objects. As illustrated in FIG. 7E, the FD_SET of sockets is provided or available at 362, and in decision block 364, the method provides for determining if all sockets in FD_SET are UDP sockets. If all sockets in FD_SET are not UDP sockets, a “no” to decision block 364, then the standard or regular select function is called in operation 366. If all sockets in FD_SET are UDP sockets, a “yes” to decision block 364, embodiments of the present invention provide that the select function needs to find all of the local queue objects passed in through the FD_SET as shown by operation 368. Then, it has to loop through every queue object specified in the FD_SET, achieved by decision block 370. If the queue has data, a “yes” to decision block 372, the value of that socket handle is set in the returning FD_SET at operation 374. After every queue object has been checked, if there is at least one socket that has data, a “yes” to decision block 376, the select function returns to the calling function, in one embodiment. However, if none of the data queue objects has data ready, a “no” to decision block 376, then the select function will need to determine the wait time, which is illustrated in the continuation of logic flowchart diagram 360 in FIG. 7F.

FIG. 7F is the continuation of logic flowchart diagram 360 of FIG. 7E in accordance with one embodiment of the present invention. Generally, the wait condition is passed as a select function parameter from the calling function. If the timeout parameter structure is NULL, a “yes” to decision block 378, the assumption is that the select function should wait indefinitely until the one of more of the data queue objects has data, as shown in operation 380. If the timeout structure is something other than NULL, a “no” to decision block 378, but the timeout value is set to 0, a “yes” to decision block 382, then the select function returns immediately. In this situation, the select function will wait up to the time specified in the timeout structure. If any of the data queues in interest have data available prior to timeout, a “no” to decision block 378, and a “no” to decision block 382, the logic flow provides for waiting for data to be available in operation 384, reporting the finding to the calling function in operation 386, and then the selection function returns.

FIG. 7G is a logic flowchart diagram 390 illustrating the logic flow of the socket: accept operation of the WinSockProxy.dll in accordance with one embodiment of the present invention. The logic flow begins with calling the standard accept call in operation 392, and then receiving the data set “struct sockaddr” which holds the remote IP address at 394. In decision block 396 it is determined whether the remote IP (from the data set) is actually a local IP, signifying a local loopback connection. If the remote IP is not a local IP, a “no” to decision block 396, the call is returned. If the remote IP is actually a local IP, a “yes” to decision block 396, the logic flow proceeds to read the remote IP address from the tunneling header (see FIG. 6B) in operation 398, set the return remote IP address to the remote IP address in operation 400, and then record the socket handle, the remote IP and the remote port in operation 402. In one embodiment of the present invention, the logic flow for the socket: accept call is typically implemented on the server side for TCP redirect.

FIG. 7H is a logic flowchart diagram 410 illustrating the logic flow of the socket: getpeername operation of the WinSockProxy.dll in accordance with one embodiment of the present invention. Similar to the socket: accept call described above in reference to FIG. 7G, the logic flow for socket: getpeername begins with calling the standard getpeername call in operation 412. The data set “struct sockaddr” is provided at 414, and then it is determined whether the socket handle is a local loopback connection. If the socket handle is not a local loopback connection, a “no” to decision block 416, the getpeername call is returned. If the socket handle is a local loopback connection, a “yes” to decision block 416, the logic flow provides for changing the remote IP from that listed in the sockaddr to the redirected remote IP. In one embodiment, the socket: getpeername call is primarily implemented for TCP redirection.

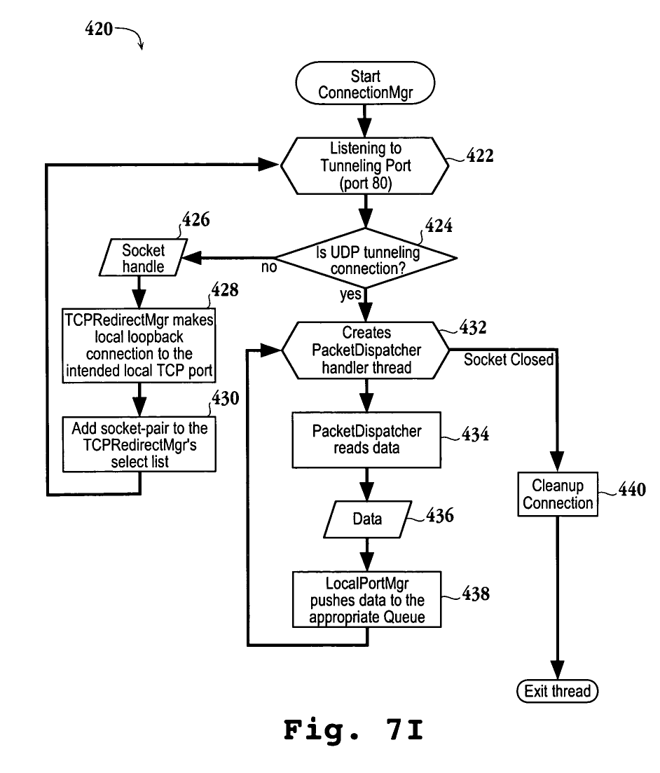

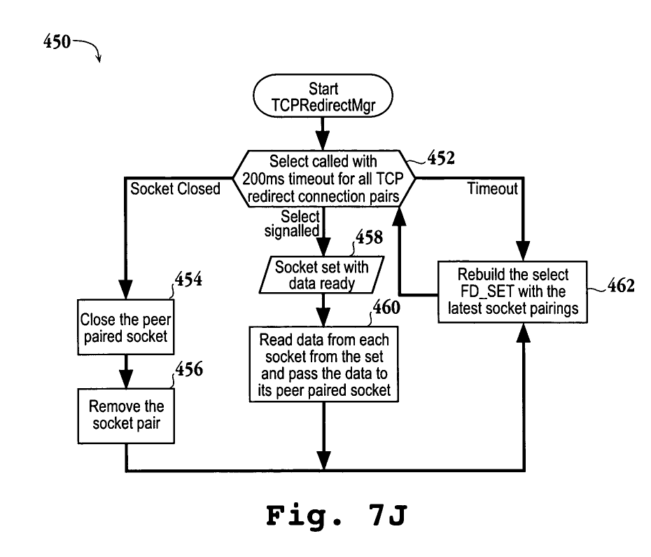

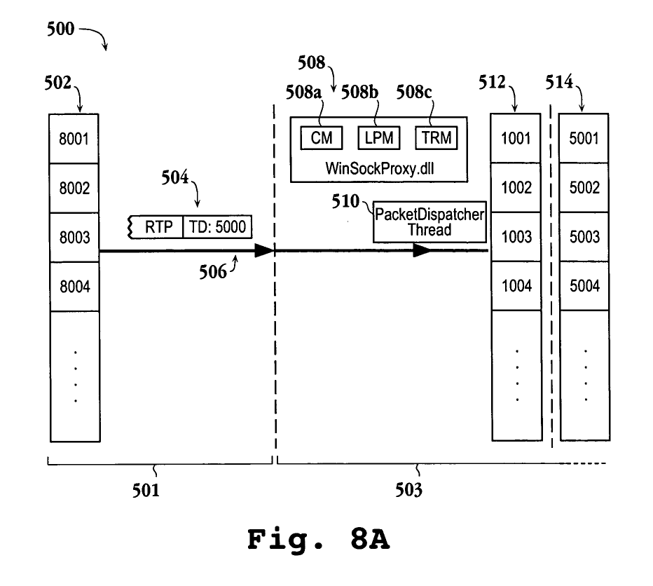

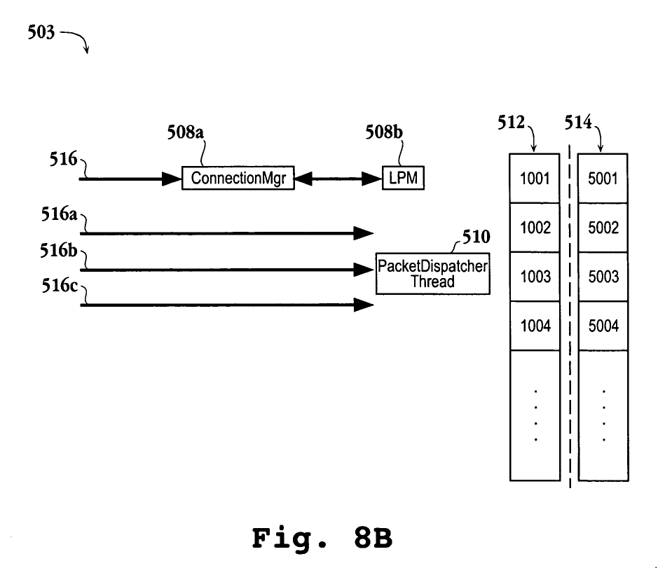

FIG. 71 is a logic flowchart diagram 420 illustrating the logic flow of a background listening operation of the WinSockProxy.dll in accordance with one embodiment of the present invention. As indicated in preparation operation 422, the logic flow begins from a stand-by or listening operation in which embodiments of the present invention maintain a listening monitor of tunneling TCP port 80. Upon receipt of a connection request, the logic flow determines whether the request is a UDP tunneling connection (i.e., by examining the connection header, see FIG. 6A). If the connection is not a UDP tunneling connection, a “no” to decision block 424, the logic flow includes input from a “socket handle” data set, and then in operation 428, the TCPRedirectMgr component of the WinSockProxy.dll module makes a local loopback connection to the intended local TCP port. In operation 430, the socket-pair is added to the TCPRedirectMgr's select list. The logic flow further provides for continued monitoring of the tunneling port.

If in decision block 424, the request is for a UDP tunneling connection, a “yes” to the decision block, the logic flow provides for creating a PacketDispatcher handler thread. In one embodiment, the PacketDispatcher handler thread is created to manage and process UDP data packets received through the tunneling connection. The PacketDispatcher handler thread is another component of the WinSockProxy.dll module, in one embodiment. The PacketDistpatcher handler thread (one per tunneling peer or system, in one embodiment) communicates with the LocalPortMgr to dispatch the UDP data to its originally intended UDP ports. So long as the thread is running, the logic flow, as represented in operations 434 and 438, with UDP data input 436, provides for reading the data, and pushing or dispatching the data to the appropriate queue (or UDP dispatch port). When either the client or the server application closes the connection, cleanup is performed in operation 440, and the thread is exited.

FIGS. 8A and 8B are provided to illustrate the implementation of a PacketDistpatcher handler thread and UDP dispatch ports. FIG. 8A is a high level schematic 500 showing the dispatching of UDP tunneling data using locally opened UDP ports in accordance with one embodiment of the present invention. FIG. 8A shows UDP data flow from a client side 501 to a server side 503. In one embodiment of the invention, a client H.323 application opens from one to a plurality of UDP data ports 502 from which real time, multi-media data is transmitted. The client H.323 application opens the from one to a plurality of UDP data ports 502, source data ports, and transmits the UDP data to addressed or destination UDP data ports 514 of a server H.323 application. In accordance with embodiments of the present invention as described above, the UDP data is intercepted by a client WinSockProxy.dll and channeled into a tunneling TCP data connection, in one embodiment, or into multiple tunneling TCP data connections, in another embodiment. The data stream 504, is transmitted in accordance with real-time transport protocol, addressed to the addressed or destination UDP data ports 514 of the server H.323 application.

On the server side 503, the tunneling TCP data connection is intercepted by the server WinSockProxy.dll 508. As described above in detail, embodiments of the server WinSockProxy.dll include a ConnectionMgr module 508a, a LocalPortMgr module 508b, and a TCPRedirect module 508c. In one embodiment, UDP data transmitted through one or more tunneling TCP connections is received by the ConnectionMgr module 508a and dispatched to the LocalPortMgr module 508b. In another embodiment, one or more PacketDispatcher handler threads 510 is created to manage the UDP data received through a tunneling TCP connection. As described above in reference to FIG. 71, the PacketDispatcher handler thread 510 reads the tunneled UDP data, which is then pushed to the LocalPortMgr 508b to a data queue, in one embodiment, or to one or more UDP data ports in another embodiment. In the embodiment illustrated in FIG. 8A, a plurality of local UDP data ports 512 are opened, and the tunneled UDP data is dispatched to the plurality of local UDP data ports 512. In one embodiment, the LocalPortMgr 508b matches one or more local UDP ports with the addressed UDP data ports 514 so that when the server H.323 application calls or obtains the data from each of the addressed UDP data ports 514, the data passed to the local UDP data ports 512 matched to the called port 514 is provided.

FIG. 8B is a detail view of the server side 503 of the dispatching of UDP tunneling data using locally opened UDP ports illustrated in FIG. 8A. In one embodiment of the invention, UDP data is received in a TCP tunneling connection 516 and intercepted by the ConnectionMgr 508a of the server WinSockProxy.dll 508 (see FIG. 8A). ConnectionMgr 508a dispatches the TCP tunneling connections 516a, 516b, 516c to the PacketDispatcher handler thread 510. And the PacketDispatcher handler thread 510 dispatches the UDP data through LocalPortMgr 508b. As described above, PacketDispatcher handler thread 510 reads the UDP data and LocalPortMgr 508b then dispatches the UDP data. In the illustrated embodiment, WinSockProxy.dll 508 (see FIG. 8A) has opened a plurality of local UDP data ports 512, which are paired with the destination or addressed UDP data ports 514 that have been opened by the server H.323 application. When the server H.323 application calls or receives data from the addressed UDP data ports 514, the data in the corresponding local UDP data port 512 is provided. In one embodiment, the local UDP data ports 512, also referred to as dispatching ports, are transparent to both the client H.323 application and the server H.323 application. The server WinSockProxy.dll creates the local UDP data dispatching ports 512 to manage UDP data. Both the client H.323 application and the server H.323 application address and utilize the from one to a plurality of addressed or destination UDP data ports 514.

In one embodiment of the invention, from one to a plurality of tunneling TCP connections are opened for transmitting UDP data. FIG. 8B illustrates a plurality of tunneling TCP data connections 516a, 516b, and 516c, each connection processed as described above. In one embodiment, a PacketDispatcher handler thread 510 is created for each tunneling peer or client system. Therefore, as illustrated in FIG. 8B, one PacketDispatcher handler thread 510 is created for the three tunneling TCP data connections 516a, 516b, 516c, since all three connections are from the same tunneling client system. In one embodiment, advantages of using multiple tunneling connections include both reliability and performance. As is known, if there is packet loss in TCP transmission, the connection will stop sending new data until the lost data has been retransmitted and received. The retransmission and acknowledgement process, however, negatively affects the performance of real-time streaming applications. With more than one TCP tunneling connection, in one embodiment, data can be sent by another TCP connection while one of the possibly delayed connections manages the retransmission.

Turning back to the final logic flowchart, FIG. 7J is a logic flowchart diagram 450 illustrating the logic flow of a TCPRedirectMgr function of the WinSockProxy.dll in accordance with one embodiment of the present invention. As described above in detail, the WinSockProxy.dll module includes three components, including the TCPRedirectMgr component, which processes all of the TCP redirect connections in one embodiment of the invention. FIG. 7J is essentially the run time of the TCPRedirectMgr.

In one embodiment of the present invention, WinSockProxy calls select with a 200 ms timeout for all TCP redirect connection pairs, at any time a TCP connection request or data stream is created or received. The calling of select creates the file descriptor set (FD_Set) for all pairs of TCP redirect tunneling connections and its local counter loopback TCP connection. Then, the TCPRedirectMgr goes into a select wait state, 452, where it waits for data availability on any of the sockets in the FD_SET. TCPRedirectMgr waits up to 200 ms (timeout) for data availability on any of the sockets. If timeout occurs before any data is available in any of the sockets, the TCPRedirectMgr will check and update the FD_SET with the latest set of all sockets, 462. While the TCPRedirectMgr thread is waiting for data, a new TCP redirection connection may have come in and have been dispatched by the ConnectionMgr to the TCPRedirectMgr object. As a result, the TCPRedirectMgr thread needs to update its FD_SET periodically. Then, the TCPRedirectMgr goes back to the beginning of the cycle, 452

If there is data available before the 200 ms timeout, 458, the TCPRedirectMgr reads data from each socket that has data ready to be read, 460, and resends the data unmodified to its other socket of the socket pair (a socket pair consists of one socket for the tunneling TCP connection from the remote peer and one local loopback TCP connection to the client originally intended TCP port). After all of the data from all of the sockets which indicated there is data available in 458, the TCPRedirectMgr updates its FD_SET with the latest set of TCP connection pairs, 462. Then goes back to the beginning of the cycle, 452.

In one embodiment, during the wait at 452, if the select function call returns that there are one or more sockets are being closed, the TCPRedirectMgr removes that socket and closes its peer socket in the socket pair at 454, and removes the socket pair 456. Then, the TCPRedirectMgr updates the FD_SET with the latest set of TCP connection pairs, 462. The operation then loops back to the beginning of the cycle, 452.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a medium, e.g., a computer readable medium. The computer readable medium is any data storage device that can carry or store data, which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for transmitting multimedia data associated with a multimedia application, comprising:
establishing a TCP/IP connection between a client application and a server application;
channeling a UDP data connection into a tunneling TCP data connection;
re-directing a TCP data connection to a tunneling TCP port, the re-directing including intercepting the TCP data connection and re-directing the TCP data connection from a locally called TCP port through the tunneling TCP port;
receiving the channeled UDP data connection and dispatching the UDP data connection to a local UDP data port; and
receiving the re-directed TCP data connection and re-directing the TCP data connection to a local TCP data port.

2. The method of claim 1, further comprising:
accessing a WinSockProxy dynamic linked library, the WinSockProxy dynamic linked library enabling the channeling of the UDP data connection and enabling the re-directing of the TCP data connection.

3. The method of claim 1, further comprising:
channeling from one to a plurality of UDP data connections into one or more TCP tunneling connections.

4. The method of claim 1, further comprising:
re-directing from one to a plurality of TCP data connections to a corresponding from one to a plurality of TCP data ports.

5. The method of claim 1, further comprising:
providing a UDP data queue, the UDP data queue being configured to receive the dispatched UDP data connection.

6. A medium or waveform containing a set of instructions adapted to direct a machine to perform the method of claim 1.

7. A method of transmitting data, comprising:
intercepting a data stream at an application level of a client system;
directing the intercepted data stream to a tunneling port; and
forwarding the intercepted data stream to a TCP/IP driver through the tunneling port.

8. The method of claim 7, further comprising:
receiving a transmitted data stream at a network driver level of a server system;
forwarding the received data stream to a server application;
intercepting the forwarded data at an application level of the server application;
re-directing intercepted TCP data to local TCP data ports; and
dispatching intercepted UDP data to one or more local UDP data ports.

9. The method of claim 7, wherein the intercepted data stream includes a UDP data stream and a TCP data stream.

10. The method of claim 9, wherein the directing the intercepted data stream to the tunneling port comprises:
channeling intercepted UDP data into a tunneling TCP data connection; and
re-directing intercepted TCP data to a tunneling TCP port.

11. The method of claim 10, further comprising:
channeling the intercepted UDP data into from one to a plurality of tunneling TCP data connections.

12. A system for transmitting multi-media data across a distributed network, comprising:
a first computing system configured to transmit a multi-media data stream, the multi-media data stream being transmitted through a transmitting tunneling port; and
a second computing system configured to receive the multi-media data stream through a receiving tunneling port,
wherein the first computing system intercepts UDP data and channels the UDP data through a transmitting tunneling TCP data port, and further intercepts TCP data and re-directs the TCP data to a transmitting tunneling TCP data connection, and the second computing system receives the channeled UDP data through a receiving tunneling TCP data port, and receives the re-directed TCP data stream through a receiving tunneling TCP data connection.

13. The system of claim 12, further comprising:
a client WinSockProxy dynamic linked library, the client WinSockProxy dynamic linked library configured to intercept a UDP data connection at an application level of the first computing system and to channel the intercepted UDP data connection through the transmitting tunneling TCP data port.

14. The system of claim 13, wherein the client WinSockProxy dynamic linked library is configured to intercept from one to a plurality of UDP data connections at an application level of the first computing system and to channel the intercepted from one to a plurality of UDP data connections through from one to a plurality of transmitting tunneling TCP data ports.

15. The system of claim 12, further comprising:
a client WinSockProxy dynamic linked library, the client WinSockProxy dynamic linked library configured to intercept a TCP data connection at an application level of the first computing system and to re-direct the intercepted TCP data connection through the transmitting tunneling TCP data connection.

16. The system of claim 12, further comprising:
a server WinSockProxy dynamic linked library, the server WinSockProxy dynamic linked library configured to intercept the channeled UDP data received through the receiving tunneling TCP data port at an application level of the second computing system and to dispatch the channeled UDP data to a local UDP port of the second system.

17. The system of claim 12, further comprising:
a server WinSockProxy dynamic linked library, the server WinSockProxy dynamic linked library configured to intercept the channeled UDP data received through the receiving tunneling TCP data port at an application level of the second computing system and to dispatch the channeled UDP data to a UDP data queue of the second system.

18. The system of claim 12, further comprising:
a server WinSockProxy dynamic linked library, the server WinSockProxy dynamic linked library configured to intercept the re-directed TCP data stream received through the receiving tunneling TCP data connection at an application level of the second computing system and to further re-direct the intercepted re-directed TCP data stream to a local TCP data connection.

19. A communication protocol for enabling multi-media communication between computing devices, comprising:
at an application level configured to open a TCP data port for transmitting TCP data and further configured to open a UDP data port for transmitting UDP data, a WinSockProxy dynamic linked library,
wherein the WinSockProxy dynamic linked library is configured to intercept the TCP data transmitted in the TCP data port and to re-direct the TCP data to a tunneling TCP data port, and further configured to intercept the UDP data transmitted in the UDP data port and to channel the UDP data into another tunneling TCP data port.

20. The communication protocol of claim 19, wherein the application level is configured to open from one to a plurality of TCP data ports for transmitting TCP data, and is further configured to open from one to a plurality of UDP data ports for transmitting UDP data.
